(19) United States
(12) Patent Application Publication
(10) Pub. No.: US 2007/0212191 A1
(43) Pub. Date: Sep. 13, 2007

(54) Two piece weld nut

(76) Inventors: Martin J. Nilsen, Hampshire, IL (US); Michael E. Ward, Geneva, IL (US); James M. Van Ingen, Algonquin, IL (US)

Correspondence Address: ILLINOIS TOOL WORKS INC., 3600 WEST LAKE AVENUE, PATENT DEPARTMENT, GLENVIEW, IL, 60025, US

(21) Appl. No.: 11/639,503

(22) Filed: Dec. 15, 2006

Related U.S. Application Data
(60) Provisional application No. 60/781,056, filed on Mar. 10, 2006.

(51) Int. Cl. F16B 39/24

(52) U.S. Cl. 411/162

(57) ABSTRACT

A weld nut includes a separate nut and a separate weld plate engaged one with the other to constrain relative axial movement of one with respect to the other. Confronting surfaces along an interface of the nut and weld plate are configured to interfere one with the other and constrain relative rotational movement between the nut and weld plate.

### CROSS-REFERENCE TO RELATED APPLICATIONS

The present regular United States Patent Application claims the benefits of U.S. Provisional Application Ser. No. 60/781,056 filed on Mar. 10, 2006.

### FIELD OF THE INVENTION

The present invention relates generally to fasteners and, more particularly, the invention pertains to fasteners such as weld nuts that are secured in assemblies for subsequent engagement by a complementary fastener component such as a bolt or stud.

### BACKGROUND OF THE INVENTION

It is known to use so-called weld nuts as part of fastener systems in a variety of installations and assemblies. It is known to secure the weld nut in a fixed position for later engagement with the complementary component of the fastener system, particularly when it is difficult to access the location at which the nut is to be installed for completing the assembly. For example, it is known to use weld nuts in various locations on automobiles where components later secured thereto are positioned in a laid on assembly that covers the nut before the fastener is secured. Weld nuts are used also in installations in which the anchoring component is of insufficient thickness to be threaded for anchoring a fastener, such as a bolt, directly. Weld nuts are used also to improve speed and efficiency in later assembly, even when the nut is accessible in the subsequent assembly. For example, it is known to provide a two-piece weld nut in which a weld plate is provided with a round hole and a nut includes a collar or hub secured in the hole. The nut and weld plate are rotatable relative to one another.

Weld nuts have worked satisfactorily for these and other installations, but are not without deficiencies. For example, in blind installations wherein the nut is not accessible as the assembly is being completed, it is necessary for the nut to be secured and not rotatable relative to the weld plate. The aforedescribed two piece weld nut assembly in which the nut and plate are rotatable relative to each other is not suitable for such installations. For these installations, other types of weld nuts have been used. For example, a weld nut can be made from a single, monolithic piece of material including the threaded fastener component and a plate-like component by which the weld nut is anchored in the assembly. However, techniques used for shaping a nut and a weld plate from a single piece of material have been expensive and wasteful of material. Other structures also have been used, including two piece weld nut assemblies in which one or more nut is welded to a weld plate which is subsequently welded in the assembly. Again, manufacturing techniques for weld nuts of this type can be time consuming and expensive.

It is known also to provide a plurality of projections or weld nibs on the surface of the weld nut which is to confront the anchoring or supporting material. The weld nut is then secured to the supporting material by resistance welding, which causes the projections to flow and alloy with the supporting material. It can be difficult to see if acceptable alloying has occurred in that the weld nibs are beneath the plate. Also, flash from the welding process can contact threaded portions of the weld nut, causing thread damage and difficult subsequent engagement with a bolt or other threaded component attached thereto. If the welds are not secure, or if the fastening system is subjected to excessive torque or other forces, the weld zones can break loose, allowing the weld nut to spin when the complementary fastener portion is connected thereto or disconnected therefrom. Excessive force conditions as described can occur particularly if weld flash during the attachment of the weld nut has come in contact with the threads of the weld nut, thereby increasing torque requirements to thread the bolt into the weld nut. Excessive force conditions also can occur if the thread on the weld nut is malformed or damaged during handling and installation.

### SUMMARY OF THE INVENTION

The present invention provides a two piece weld nut in which simple stamping processes are used to engage the nut and weld plate to restrain relative axial movement therebetween, and wherein an interface between the nut and weld plate is configured to prevent relative rotation between the weld nut and weld plate.

In one aspect thereof, the present invention provides a fastener assembly with a plate defining a hole and a fastener having a hub disposed in the hole. The hub is secured in the hole, and the plate and the fastener are substantially immovable axially one relative to the other. The plate and the fastener have confronting surfaces establishing an interface between the plate and the fastener, the confronting surfaces including complementary configurations interfering one with the other in either direction of relative rotation between the plate and the fastener with the hub in the hole.

In another aspect thereof, the present invention provides a weld nut with a nut having a body with a threaded bore and a hub extending axially from the body. The hub is narrower than the body and the body has an end surface radially outward of the hub. A first set of contours is provided on the end surface of the body. A plate has a hole and a nut facing surface. A second set of contours is provided on the nut facing surface of the plate. The hub is secured in the opening, and the nut and the plate are substantially immovable axially one relative to the other. The first and second contours internest one with the other, the contours abutting one against the other to limit relative rotational movement between the nut and the plate.

In a still further aspect thereof, the present invention provides a fastener assembly with a threaded body having an end surface and a hub extending axially from the end surface of the body. The end surface outwardly of the hub defines alternating ridges and valleys. A plate has a hole, and the hub is disposed in the hole and secured to the plate in a manner to constrain relative axial movement between the body and the plate. A surface of the plate defines a second set of alternating valleys and ridges internested with the ridges and the valleys of the end surface.

An advantage of the present invention in one form thereof is providing a weld nut that can be manufactured in a cost efficient manner.

Another advantage of a form of the present invention is providing a weld nut having weld nibs remotely located relative to the threads of the weld nut, to reduce potential for thread damage resulting from weld flash contacting the threads when the weld nut is installed in an assembly.

A further advantage of a form of the invention is providing a weld nut as a two piece assembly so that the nut and weld plate portions thereof can be provided of different materials.

A still further advantage of a form of the present invention is providing a weld nut in which the nut and weld plate thereof are rotationally secured, one with respect to the other so that relative rotation between the nut and weld plate portions are inhibited.

Other features and advantages of the invention will become apparent to those skilled in the art upon review of the following detailed description, claims and drawings in which like numerals are used to designate like features.

### BRIEF DESCRIPTION OF THE DRAWINGS

FIG. 1 is a perspective view of a two piece weld nut in accordance with the present invention;

FIG. 2 is a perspective view of another form of a weld nut of the present invention, illustrating a bottom of the weld nut;

FIG. 3 is a perspective view of the nut portion for the weld nuts shown in the preceding drawings;

FIG. 4 is a cross-sectional view of the weld nut shown in FIG. 2;

FIG. 5 is a perspective view similar to that of FIG. 1, but illustrating another modified form of the present invention;

FIG. 6 is an exploded view of another embodiment of the present invention;

FIG. 7 is an exploded view of yet another embodiment for a two piece weld nut of the present invention;

FIG. 8 is an exploded view of a further embodiment for a two piece weld nut of the present invention; and

FIG. 9 is an exploded view of still another embodiment for a two piece weld nut of the present invention.

Before the embodiments of the invention are explained in detail, it is to be understood that the invention is not limited in its application to the details of construction and the arrangements of the components set forth in the following description or illustrated in the drawings. The invention is capable of other embodiments and of being practiced or being carried out in various ways. Also, it is understood that the phraseology and terminology used herein are for the purpose of description and should not be regarded as limiting. The use herein of “including”, “comprising” and variations thereof is meant to encompass the items listed thereafter and equivalents thereof, as well as additional items and equivalents thereof.

### DETAILED DESCRIPTION OF THE PREFERRED EMBODIMENT

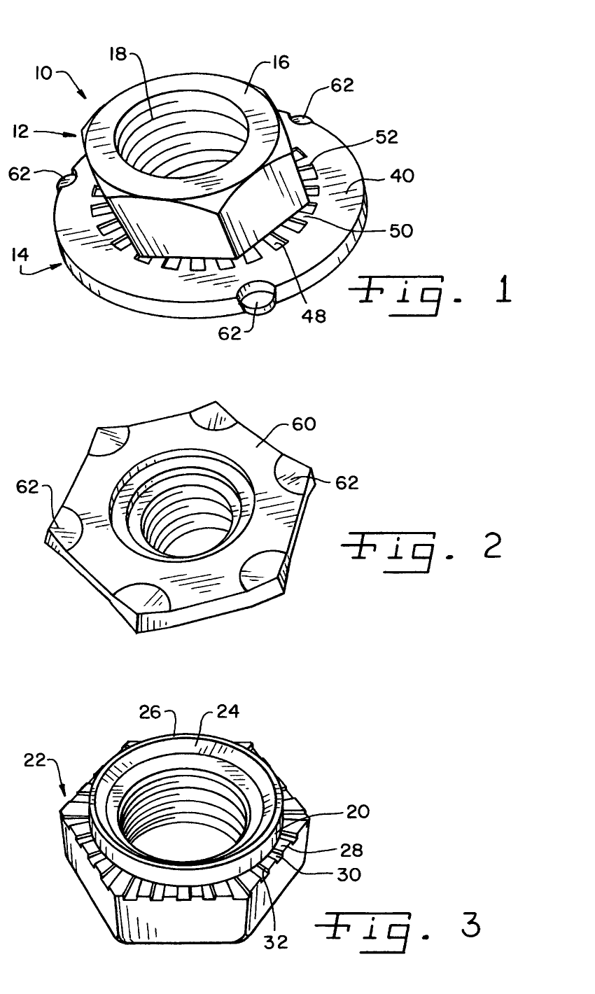

Referring now more specifically to the drawings, and to FIG. 1 in particular a fastener assembly in the form of a weld nut 10 in accordance with the present invention is shown. Weld nut 10 is a two piece assembly including a fastener such as a nut 12 and a weld plate 14. Weld nut 10 can be made of a variety of materials including metals and the like. An advantage of certain forms of the present invention is that nut 12 and weld plate 14 can be provided from different materials. Accordingly, nut 12 can be made of material advantageous for the fastening function, such as brass or other costly material, and weld plate 14 can be made of a lesser expensive material, such as steel, more suited for welding attachment within the assembly.

Nut 12 includes a main body 16 having an axial opening therethrough defining a thread 18 for engagement with a complementary threaded stud, bolt or the like (not shown). A hub 20, best seen in FIG. 3, extends axially away from one end surface 22 of body 16. Hub 20 is narrower than body 16 such that end surface 22 extends radially outwardly relative to hub 20. In the illustrated embodiment shown in FIGS. 1-5, hub 20 has a round periphery and has a tapered inner surface 24 whereby a distal end edge 26 of hub 20 is thinner than portions of hub 20 closer to body 16.

End surface 22 is provided with a first set of contours including alternating ridges 28 and valleys 30. In the illustrated embodiment, ridges 28 and valleys 30 extend substantially radially outwardly along end surface 22. Ridges 28 and valleys 30 are substantially square cut, such that the bottoms of valleys 30 are flat and the tops of ridges 28 are flat, with substantially flat sides 32 that are substantially perpendicular to the flat upper surface of an adjacent ridge 28 and the flat bottom surface of an adjacent valley 30.

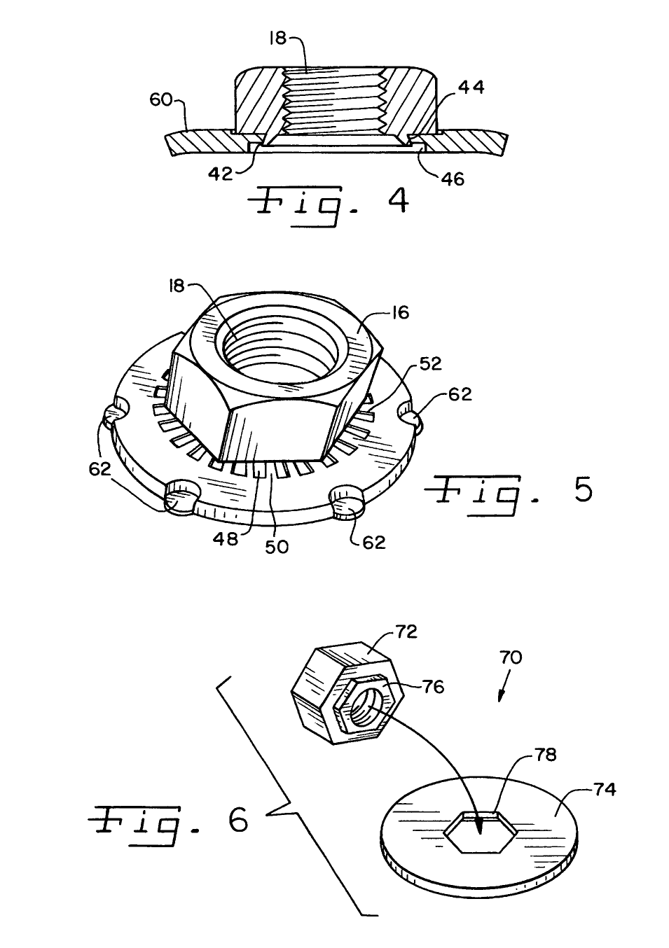

Weld plate 14 in the exemplary embodiment is a substantially flat, washer-like body, although other shapes and configurations can be used also. FIG. 1 illustrates a round weld plate 14 having a nut facing surface 40. Weld plate 14 defines a hole 42 configured for receiving hub 20 therein. As illustrated in FIG. 4, hole 42 can include a tapered surface 44 expanding outwardly away from surface 40. Hole 42 also can define an undercut 46 and a diametrically larger opening at a surface opposite nut facing surface 40.

Nut facing surface 40 defines a second set of contours including valleys 48 and ridges 50 shaped and arranged to complement ridges 28 and valleys 30 whereby each are received one within the other in a nested arrangement. Accordingly, ridges 28 are received in valleys 48 and ridges 50 are received in valleys 30. Accordingly, valleys 48 and ridges 50 extend radially outwardly from hole 42 over nut facing surface 40. Depending on the overall size of weld plate 14, valleys 48 and ridges 50 need not extend completely to the outer edge of weld plate 14 so long as each are of sufficient length for complete nesting with ridges 28 and valleys 30 of nut 12. Valleys 48 and ridges 50 are square cut similarly to that described previously for ridges 28 and valleys 30. Accordingly, nut facing surface 40 is provided with substantially flat bottoms for valleys 48 and substantially flat tops for ridges 50, with substantially flat sides 52 perpendicular to the adjacent valleys 48 and ridges 50.

In an assembled weld nut 10, hub 20 is inserted into hole 42 and ridges 28 and valleys 30 of end surface 42 are nested into valleys 48 and ridges 50 of nut facing surface 40. Hub 20 is expanded, crushed, deformed or otherwise manipulated to secure hub 20 in hole 42, whereby relative axial movement between nut 12 and weld plate 14 is constrained. Manipulation of hub 20 to secure it in hole 42 can be performed by pressing, as those skilled in the art will readily understand. The thinner wall along surface 24 toward distal end edge 26 can facilitate outward expansion of hub 20. Portions of end edge 26 can be expanded into undercut 46, to secure relative axial positioning of nut 12 and weld plate 14.

Nut 12 and weld plate 14 are held tightly one against the other such that the interface of end surface 22 and nut facing surface 40 includes the nesting of ridges 28 in valleys 48 and ridges 50 in valleys 30. Relative rotation between nut 12 and weld plate 14 is thereby restricted in both directions. The substantially square cut configurations of ridges 28, valleys 30, ridges 48 and valleys 50 establish torque resistance to relative rotation between nut 12 and weld plate 14.

Whereas weld plate 14 in the embodiments illustrated in FIGS. I and 5 is substantially round, it should be understood that other configurations also can be used. For example, the embodiment of FIG. 2 includes a weld plate 60 having a hex shaped perimeter.

Weld nibs 62 are provided for securing weld nuts of the present invention on the supporting body (not shown). FIG. 1 illustrates an embodiment having three weld nibs 62. FIG. 2 and FIG. 5 illustrate embodiments having more weld nibs 62. The number, location and spacing for weld nibs 62 can be selected for advantageous installation and attachment on the supporting structure. Weld nibs 62 are provided at the outer edge of the weld plate. Accordingly, flash that may occur during the installation process is more distantly located from thread 18, thereby reducing the risk for damage to thread 18 from contact with the weld flash. Further, with the bonding or alloying performed at more distant locations from the center axis of the weld nut assembly, greater torque resistance is provided to reduce the risk of the weld nut being dislodged from its installed position. Further, in some situations, weld nibs 62 at the perimeter of the weld plate can allow for visual inspection of the weld integrity during installation.

In the embodiments thus far described, the interface between nut 12 and weld plate 14 or 60 is established along a substantially radial plane relative to the axis of the weld nut. Accordingly, hub 20 of nut 12 and hole 42 of the weld plate can be round, and. Thus, precise rotational orientation of the nut with respect to the weld plate during assembly is not required. With relatively narrow ridges and valleys, as pressing is performed to secure nut 12 in weld plate 14 or 60, the ridges and valleys are drawn into the required nesting relationship.

It should be understood that other configurations for an interfering relationship between the interface of a nut and weld plate also can be used. For example, an outer surface of the hub and the hole in the weld plate can be complementarily shaped to restrict relative rotation between the nut and weld plate. FIG. 6 illustrates a weld nut 70 including a nut 72 and a weld plate 74. Nut 72 includes a hex-shaped hub 76, and weld plate 74 defines a complementary hex-shaped hole 78.

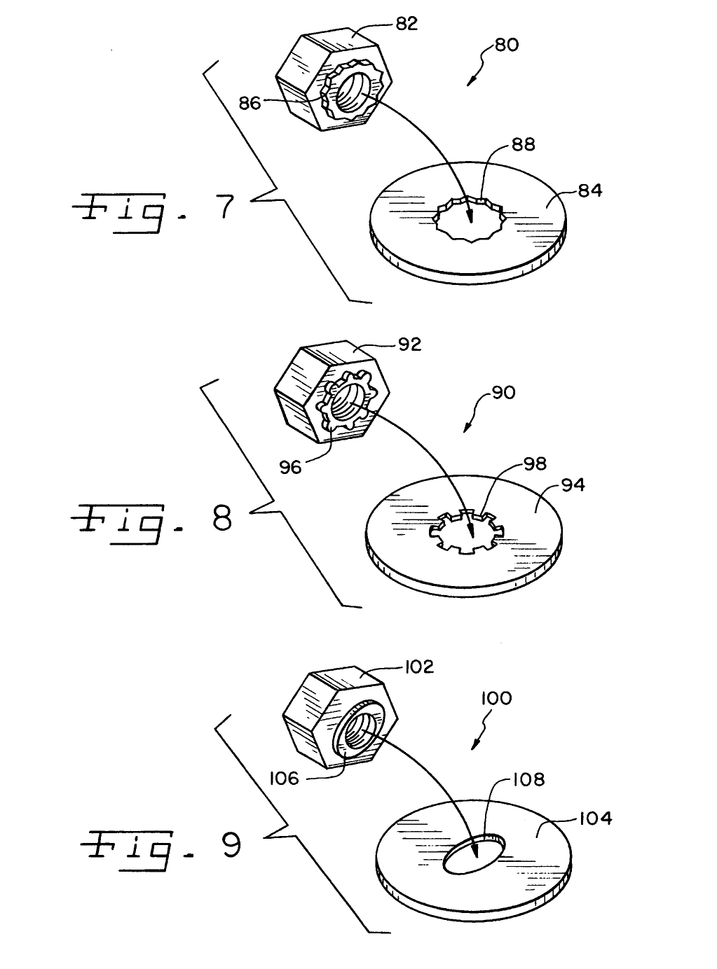

In FIG. 7, a weld nut 80 includes a nut 82 and a weld plate 84. A hub 86 of nut 82 includes a spline-like configuration of alternating ridges and valleys, and weld plate 84 defines a complementarily notched opening 88 for engaging the spline configuration of hub 86.

FIG. 8 illustrates a weld nut 90 including a nut 92 and a weld plate 94. A hub 96 is shaped similarly to a gear, and a hole 98 of weld plate 94 is complimentarily shaped for receiving hub 96.

FIG. 9 illustrates a still further embodiment of the present invention in which a nut plate 100 includes a nut 102 and a weld plate 104. A hub 106 of nut 102 is oval in shape, and weld plate 104 defines an oval hole 108 for receiving hub 106.

The attachment of nuts 72, 82, 92 and 102 in weld plates 74, 84, 94 and 104, respectively, can be performed by manipulation of the hubs as described previously. However, it should also be understood that any of the various hubs described herein, as well as other variations thereof, also can be secured in an appropriate weld plate opening by a press-fit or interference fit of the hub in the opening, without substantial alteration of the hub.

Variations and modifications of the foregoing are within the scope of the present invention. It is understood that the invention disclosed and defined herein extends to all alternative combinations of two or more of the individual features mentioned or evident from the text and/or drawings. All of these different combinations constitute various alternative aspects of the present invention. The embodiments described herein explain the best modes known for practicing the invention and will enable others skilled in the art to utilize the invention. The claims are to be construed to include alternative embodiments to the extent permitted by the prior art.

Various features of the invention are set forth in the following claims.

What is claimed is:

1. A fastener assembly comprising:
a plate defining a hole;
a fastener having a hub disposed in said hole, said hub being secured in said hole, and said plate and said fastener being substantially immovable axially one relative to the other; and
said plate and said fastener having confronting surfaces establishing an interface between said plate and said fastener, said confronting surfaces including complementary configurations interfering one with the other in either direction of relative rotation between said plate and said fastener with said hub in said hole.

2. The fastener assembly of claim 1, said fastener including a hub extending away from an end of said fastener, said hub being secured in said hole in said plate, and said confronting surfaces being at least a portion of said end surface of said fastener outwardly of said hub and a fastener facing surface of said plate adjacent said hole.

3. The fastener assembly of claim 1, said fastener including a hub disposed in said hole in said plate, and said confronting surfaces of said plate and said fastener being a surface defining said hole and an outer surface of said hub.

4. The fastener assembly of claim 3, said hub and said hole being oval.

5. The fastener assembly of claim 3, said hub and said hole being hex shaped.

6. The fastener assembly of claim 3, said hub having an outer surface including a plurality of ridges and valleys, and said hole defining complementary ridges and valleys for receiving said hub.

7. The fastener assembly of claim 1, said fastener being a nut.

8. A weld nut comprising:
a nut having a body with a threaded bore and a hub extending axially from said body, said hub being narrower than said body and said body having an end surface radially outward of said hub;
a first set of contours on said end surface of said body;
a plate having a hole and a nut facing surface;
a second set of contours on said nut facing surface of said plate;
said hub being secured in said opening and said nut and said plate being substantially immovable axially one relative to the other; and
said first and second contours internesting one with the other, said contours abutting one against the other to limit relative rotational movement between said nut and said plate.

9. The weld nut of claim 8, said first and second contours being substantially radially oriented alternating ridges and valleys on confronting surfaces of said nut and said plate.

10. The weld nut of claim 9, said ridges and said valleys being substantially square cut.

11. The weld nut of claim 10, said opening having an outward taper away from said nut facing surface, and said hub being expanded outwardly into said taper.

12. The weld nut of claim 11, including an undercut in said hole of said plate.

13. The weld nut of claim 8, said opening having an outward taper away from said nut facing surface, and said hub being expanded outwardly into said taper.

14. The weld nut of claim 8, including weld nibs at an outer edge of said plate.

15. A fastener assembly comprising:
a threaded body having an end surface;
a hub extending axially from said end surface of said body;
said end surface outwardly of said hub defining alternating ridges and valleys;
a plate having a hole;
said hub disposed in said hole and secured to said plate in a manner to constrain relative axial movement between said body and said plate; and
a surface of said plate defining a second set of alternating valleys and ridges internested with said ridges and said valleys of said end surface.

16. The fastener assembly of claim 15, said ridges and said valleys of said end surface and said valleys and said ridges of said surface of said plate being substantially square cut.

17. The fastener assembly of claim 16, said hole in said plate having an outward taper away from said surface of said plate, and said hub being expanded outwardly into said taper.

18. The fastener assembly of claim 17, including weld nibs at the perimeter of said plate.

19. The fastener assembly of claim 18, said ridges and said valleys of said end surface and said valleys and said ridges of said surface of said plate being substantially square cut.

20. The fastener assembly of claim 15, including weld nibs at the perimeter of said plate.
